(19) United States
(12) Patent Application Publication
(10) Pub. No.: US 2025/0196371 A1
(43) Pub. Date: Jun. 19, 2025

(54) VACUUM CONTROL METHOD FOR A PNEUMATIC GRIPPING SYSTEM

(71) Applicant: EXOTEC PRODUCT FRANCE, Croix (FR)

(72) Inventors: Bastien CAGNAC, Wasquehal (FR); Benjamin SIX, Lille (FR); Julien MOURET, Marcq en Baroeul (FR)

(73) Assignee: EXOTEC PRODUCT FRANCE, Croix (FR)

(21) Appl. No.: 18/973,620

(22) Filed: Dec. 9, 2024

(30) Foreign Application Priority Data
Dec. 18, 2023 (FR) FR2314447

(51) Int. Cl. B25J 15/06; B25J 9/16

(52) U.S. Cl. CPC B25J 15/0633; B25J 9/1612; B25J 9/1653

(57) ABSTRACT

A vacuum control method (P) for a pneumatic gripping system (10) which includes a vacuum source (26), a plurality of gripping members (13), and a pneumatic circuit (20), the pneumatic circuit (20) comprising a plurality of valves (27), each valve (27) being associated with a corresponding set of gripping members and being configured to switch between a closed position (F) and an open position (O), the pneumatic gripping system (10) including a vacuum sensor (28) adapted to measure a vacuum level in the pneumatic circuit (20) between the vacuum source (26) and the plurality of valves (27).

### TECHNICAL FIELD

This description relates to a vacuum control method for a pneumatic gripping system. This description also relates to a computer program comprising instructions for implementing such a method. This description further relates to a computer-readable storage medium on which a program for implementing the method is stored. Finally, the description relates to a gripping system adapted for implementing the method.

### BACKGROUND

In the field of logistics, it is known to carry out an operation of gripping an object by means of a robotic device comprising an arm generally movable along 5 or 6 axes, and provided at its movable end with one or more gripping members, each comprising for example a suction cup and/or foam, making it possible to grip the object.

In order for each gripping member to be able to grip the object, as shown in FIG. 1, a pneumatic circuit 200 is generally provided comprising a vacuum source 206, such as a mechanical vacuum pump or a venturi vacuum generator, configured to create, at each gripping member, the negative pressure required to grip the object.

The objects may be of different sizes, shapes and weights, or even of different surface textures, hence the need to provide a plurality of gripping members 213. In this case, the pneumatic circuit generally comprises a main pipe 201 where vacuum source 206 is arranged, and a plurality of secondary pipes 202 fluidically connected to main pipe 201 at a node 204, each secondary pipe 202 serving one of the plurality of gripping members 213. A selective opening/closing means, such as a valve 207, may also be provided at each secondary pipe 202 to allow opening or closing pneumatic circuit 200 to the atmosphere, between vacuum source 206 and the corresponding gripping member 213 served by secondary pipe 202, in order to intermittently deactivate or activate gripping member 213. In other words, each valve 207 can switch between a closed position in which the corresponding gripping member 213 is in fluid communication with vacuum source 206 and is therefore exposed to the vacuum level (or pressure) established by vacuum source 206; and an open position in which gripping member 213 is in fluid communication with the atmosphere and is therefore exposed to atmospheric pressure. In the closed position of valve 207, the corresponding gripping member 213 is able to participate in gripping the object, and in the open position of valve 207, the corresponding gripping member 213 is deactivated, and cannot participate in gripping the object.

In order to perform the gripping operation under good conditions, a sufficient vacuum level is necessary at each gripping member 213. For example, depending on the shape and/or texture of the object to be gripped, one or more of the gripping members may not be in direct and close contact with the object to be gripped, thus creating leakage to the atmosphere which impacts the vacuum level at the other gripping members. For this reason, it is desirable to be able to verify the vacuum level at each gripping member 213. Indeed, for example, in order to guarantee a sufficient gripping level of the device during a gripping operation, it may be necessary to deactivate one or more gripping members 213 among the plurality of gripping members in the case where an insufficient vacuum level, or even a leak, is detected at said one or more gripping members.

A solution known from document WO 2016/010968 consists of arranging a vacuum sensor 208 at each secondary pipe between node 204 and the corresponding gripping member 213 in order to measure a vacuum pressure at each gripping member 213. The gripping members for which the corresponding pressure sensors indicate the lowest vacuum pressures or those below a predetermined threshold are deactivated.

However, this solution has the disadvantage of requiring a sensor 208 for each gripping member 213. It is understood that in the case where the device comprises a large number of gripping members 213, then an equally large number of sensors 208 is necessary, which increases the cost and complexity of the device. On the other hand, due to the fluid communication between secondary pipes 202 at node 204, several vacuum sensors 208 may indicate an insufficient vacuum level despite the fact that only one gripping member 213 among the plurality of gripping members 213 has an insufficient vacuum level or a leak. It then proves complicated to identify with certainty said gripping member 213 having an insufficient vacuum level or a leak, among the plurality of gripping members 213.

Another solution, disclosed in DE 10 2017 110998 A1, consists of providing a vacuum sensor between a vacuum source and a plurality of suction cups arranged in parallel, each of the suction cups being connected or disconnected from the vacuum source by a switch. In order to identify a faulty suction cup, the suction cups which are initially disconnected from the vacuum source are connected sequentially to the vacuum source. After each connection, the vacuum level is determined in order to identify a possible leak from a suction cup. This solution has the disadvantage of being relatively long to implement since it requires connecting each of the suction cups one after the other to the vacuum source before gripping an object, even when there are no faulty suction cups.

### SUMMARY

A vacuum control method is proposed for a pneumatic gripping system which comprises a vacuum source, a plurality of gripping members, and a pneumatic circuit configured to place the plurality of gripping members in fluid communication with the vacuum source, the pneumatic circuit comprising a plurality of valves, each valve being associated with a corresponding set of gripping members comprising one or more gripping members among the plurality of gripping members, each valve being configured to switch between a closed position in which said valve places said corresponding set of gripping members in fluid communication with the vacuum source and an open position in which said valve places said corresponding set of gripping members in fluid communication with the atmosphere, the pneumatic gripping system further comprising at least one vacuum sensor adapted to measure a vacuum level in the pneumatic circuit between the vacuum source and the plurality of valves, the method comprising:
/A/ activating the vacuum source in order to establish a negative pressure between the plurality of gripping members and an object to be gripped,
/B/ switching the plurality of valves into their respective closed position,
/C/ positioning the plurality of gripping members on the object,
/D/ measuring a reference vacuum level by means of said vacuum sensor,
   the method comprising the following sequence /K/:
/Ka/ switching at least one valve among the plurality of valves into the open position,
/Kb/ measuring a vacuum level by means of said vacuum sensor,
/Kc/ comparing the measured vacuum level with the reference vacuum level,
/Kd/ determining that at least one of the gripping members in the set of gripping members corresponding to said at least one valve has a leak, in the case where the measured vacuum level is greater than the reference vacuum level.

Sequence /K/ may comprise a step /Kd′/ of switching said at least one valve into the closed position in the case where the measured vacuum level is equal to the reference vacuum level.

Step /D/ may comprise a subsidiary step which comprises:
comparing the reference vacuum level with a threshold vacuum level, the threshold vacuum level being determined so as to correspond to a vacuum level sufficient to allow gripping the object, and
determining that the plurality of gripping members is capable of gripping the object if the reference vacuum level is greater than or equal to the threshold vacuum level.

It is possible not to carry out sequence /K/ when the reference vacuum level is greater than or equal to the threshold vacuum level.

Step /Ka/ may comprise switching a single valve among the plurality of valves into its respective open position.

Sequence /K/ may be repeated with at least one other valve among the plurality of valves.

Sequence /K/ may be repeated with each valve among the plurality of valves.

Sequence /K/ may comprise a step /Ke/ directly or indirectly following step /Kd/ and which comprises:
comparing the vacuum level measured during step /Kc/ with the threshold vacuum level, and
determining that the gripping members of the sets of gripping members corresponding to the valves in their closed position are capable of gripping the object.

Sequence /K/ may be repeated with at least one other valve among the plurality of valves, the repeating of sequence /K/ being discontinued when the vacuum level N(k) measured in step /Kc/ is greater than or equal to the threshold vacuum level.

Sequence /K/ may comprise a step /Kf/ directly or indirectly following step /Kd/ and which comprises updating the reference vacuum level to coincide with the vacuum level measured in step /Kc/.

Sequence /K/ may comprise a step /Kh/ directly or indirectly following step /Kd/ and which comprises switching said at least one valve among the plurality of valves into the closed position.

The method may comprise a step /E/ which follows the iterative sequence /K/ and which comprises switching, into the open position, each of the valves among the plurality of valves that have been identified as being associated with a corresponding set of gripping members exhibiting a leak.

The pneumatic gripping system may comprise a single vacuum sensor between the vacuum source and the plurality of valves.

A computer program is also provided, comprising instructions for implementing the method as described above.

A computer-readable storage medium is also provided, on which is stored a program for implementing the method as described above when the program is executed by a processor.

A pneumatic gripping system is also described which comprises a vacuum source, a plurality of gripping members, and a pneumatic circuit configured to place the plurality of gripping members in fluid communication with the vacuum source. The pneumatic circuit comprises a plurality of valves, each valve being associated with a set of one or more corresponding gripping members among the plurality of gripping members, said valve being configured to switch between a closed position in which said valve places said set of one or more corresponding gripping members in fluid communication with the vacuum source and an open position in which said valve places said set of one or more corresponding gripping members in fluid communication with the atmosphere. The pneumatic gripping system further comprises at least one vacuum sensor adapted to measure a vacuum level in the pneumatic circuit between the vacuum source and the plurality of valves, and at least one control unit for executing the method as described above.

### BRIEF DESCRIPTION OF DRAWINGS

Other features, details and advantages will become apparent upon reading the detailed description below, and upon analyzing the attached drawings, in which:

FIG. 1 shows a diagram of a pneumatic circuit supplying gripping members of a pneumatic gripping system according to the prior art.

FIG. 2 shows a schematic view of a pneumatic gripping system according to this description.

FIG. 3 shows a flowchart of a vacuum control method for the pneumatic gripping system of FIG. 2.

FIG. 4 shows a diagram of a first variant of a pneumatic circuit supplying gripping members of the pneumatic gripping system of FIG. 2.

FIG. 5 shows a diagram of a second variant of a pneumatic circuit supplying gripping members of the pneumatic gripping system of FIG. 2.

FIG. 6 shows a flowchart of a first variant of an iterative sequence of the control method of FIG. 3.

FIG. 7 shows a flowchart of a second variant of an iterative sequence of the control method of FIG. 3.

FIG. 8 includes graphs that illustrate the implementation of the method according to a first scenario.

FIG. 9 includes graphs that illustrate the implementation of the method according to a second scenario.

FIG. 10 includes graphs that illustrate the implementation of the method according to a third scenario.

FIG. 11 includes graphs that illustrate the implementation of the method according to a fourth scenario.

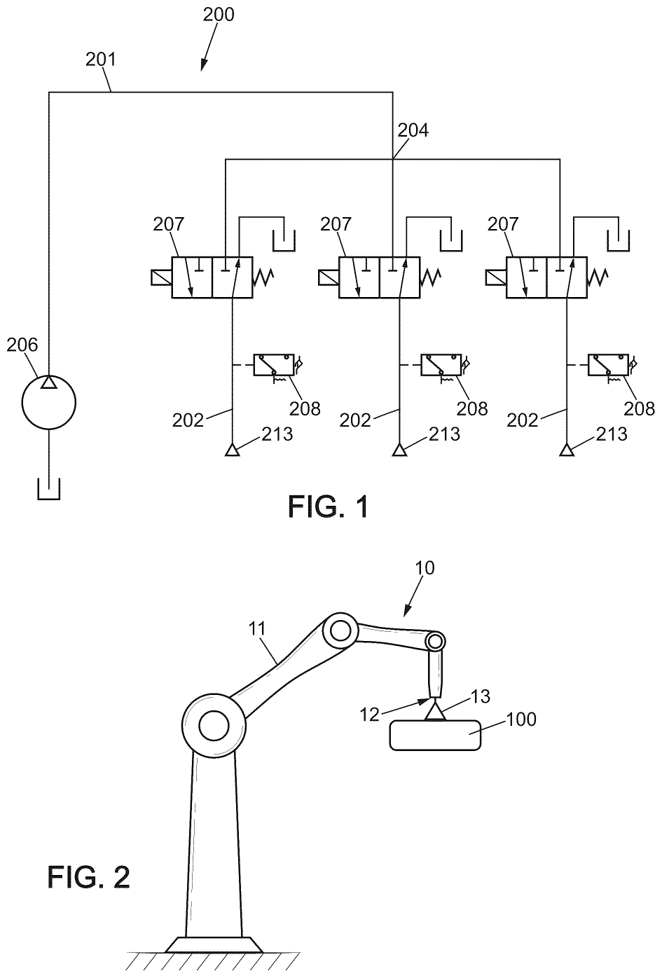

### DETAILED DESCRIPTION

A vacuum control method P for a pneumatic gripping system is now described with reference to FIGS. 2 to 7. This vacuum control method makes it possible, for example, to identify a configuration of the gripping system, in particular in terms of opening and closing valves, so that it is capable of gripping an object.

As shown in FIGS. 2, 4 and 5, pneumatic gripping system 10 comprises a vacuum source 26, a plurality of gripping members 13, and a pneumatic circuit 20 configured to place the plurality of gripping members 13 in fluid connection with vacuum source 26. Pneumatic circuit 20 comprises a plurality of valves 27, each valve 27 being associated with a corresponding set of gripping members comprising one or more gripping members 13 among the plurality of gripping members 13. Each valve 27 is configured to switch between a closed position F in which valve 27 places said corresponding set of gripping members 13 in fluid communication with vacuum source 26 and an open position O in which valve 27 places said corresponding set of gripping members 13 in fluid communication with the atmosphere. In its open position, valve 27 places said one or more corresponding gripping members 13 in fluid communication with the atmosphere, while blocking fluid communication between vacuum source 26 and said one or more corresponding gripping members 13.

Expressed in another formulation, the plurality of gripping members 13 may comprise at least i gripping members 13, i being an integer greater than or equal to 2. Pneumatic circuit 20 may be configured to place each of the i gripping members 13 in fluid communication with vacuum source 26. The plurality of valves 27 may comprise at least j valves 27, j being an integer greater than or equal to 2 and being less than or equal to i.

Pneumatic gripping system 10 further comprises at least one vacuum sensor 28 adapted to measure a vacuum level in pneumatic circuit 20 between vacuum source 26 and the plurality of valves 27. Expressed in another formulation, vacuum sensor 28 is adapted to measure a vacuum level upstream of the plurality of valves 27. The vacuum level measured by vacuum sensor 28 can be expressed as a percentage. In the case where the vacuum level is equal to 0%, this means that the pressure in pneumatic circuit 20 at vacuum sensor 28 is equal to atmospheric pressure. In the case where the vacuum level is equal to 100%, this means that the pressure in pneumatic circuit 20 at vacuum sensor 28 is zero.

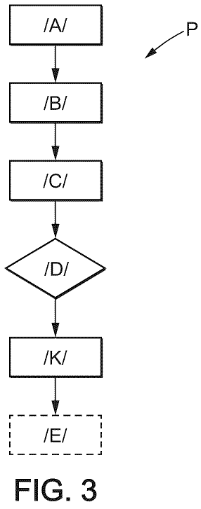

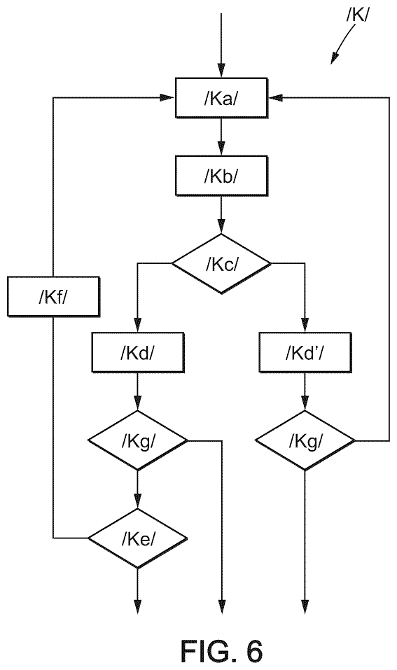

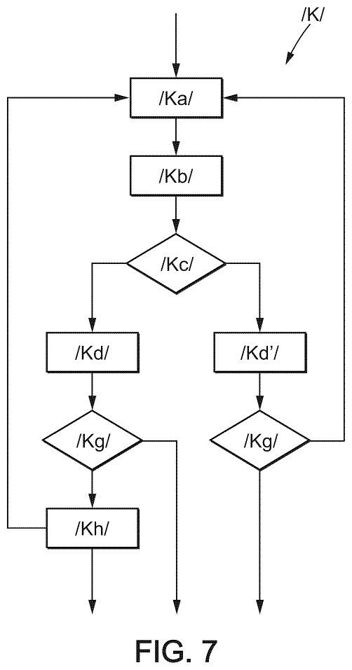

With reference to the flowchart of FIG. 3, the method P comprises:
/A/ activating vacuum source 26 in order to establish a negative pressure between the plurality of gripping members 13 and the object 100,
/B/ switching the plurality of valves 27 to their respective closed position F,
/C/ positioning the plurality of gripping members 13 on an object 100 to be gripped,
/D/ measuring a reference vacuum level Nr by means of vacuum sensor 28,
   the method P comprising sequence /K/, for which the flowchart is shown in FIGS. 6 and 7 for two variants, as follows:
/Ka/ switching at least one valve 27 among the plurality of valves 27 to the open position O,
/Kb/ measuring a vacuum level N(k) by means of vacuum sensor 28,
/Kc/ comparing the measured vacuum level N(k) with the reference vacuum level Nr,
/Kd/ determining that at least one of gripping members 13 of the set of gripping members corresponding to said at least one valve 27 has a leak in the case where the measured vacuum level N(k) is greater than the reference vacuum level Nr.

The reference vacuum level corresponds to the vacuum level measured in step /D/, i.e. when all the valves are in the closed position.

The method P advantageously requires a minimum of one vacuum sensor 28, which reduces the complexity of the pneumatic gripping system and the cost of such a pneumatic gripping system. Furthermore, the method P makes it possible to identify with certainty which valve(s) 27 associated with one or more gripping members 13 are exhibiting a leak. A leak at a gripping member 13 may in particular result from poor positioning of gripping member 13 on object 100, or from a surface condition of the object gripped by the gripping member that is unsuitable or poorly suited for gripping, for example too porous, or from a failure of a gripping member, of a valve, and/or of a pipe of the pneumatic system.

More particularly, sequence /K/ can be called “iterative sequence /K/” and thus may equivalently comprise a plurality of iterations, each iteration being defined by a rank k ranging from 1 to n, n being an integer greater than or equal to 2, each iteration of rank k comprising:
/Ka/ switching, into the respective open position O, at least one k^{th} valve 27 among the plurality of valves 27, said k^{th} valve 27 preferably being the respective valve of the iteration of rank k,
/Kb/ measuring a k^{th} vacuum level N(k) by means of said vacuum sensor 28,
/Kc/ comparing the measured k^{th} vacuum level N(k) with the reference vacuum level Nr,
/Kd/ determining that at least one of said one or more corresponding gripping members 13 associated with said at least one k^{th} valve 27 has a leak in the case where the measured k^{th} vacuum level N(k) is greater than the reference vacuum level Nr.

It may be determined during step /Kd/ that at least one of said one or more corresponding gripping members 13 associated with said at least one k^{th} valve 27 has a leak, in the case where the k^{th} vacuum level N(k) is greater than the reference vacuum level Nr by at least 10%, and preferably by at least 5%. In the iterative sequence /K/ described above and below, it is further understood that k is an integer between 1 and n.

Sequence /K/ may comprise a step /Kd′/ of switching said at least one valve 27 into the closed position F in the case where the vacuum level N(k) is equal to the reference vacuum level Nr.

Thus, in association with the iterative formulation of sequence /K/, each iteration of rank k may comprise a step /Kd′/ instead of step /Kd/. Step /Kd′/ may comprise switching the k^{th} valve 27 among the plurality of valves 27 into the respective closed position F in the case where the k^{th} vacuum level N(k) is equal to the reference vacuum level Nr. In the case where the k^{th} vacuum level N(k) is equal to the reference vacuum level Nr, it may be deduced that none of said one or more corresponding gripping members 13 associated with said at least one k^{th} valve 27 has a leak. The k^{th} vacuum level N(k) may be said to be equal to the reference vacuum level Nr within plus or minus 5%, preferably within plus or minus 2%, more preferably within plus or minus 1%. Steps /Kd′/ and /Kd/ are mutually exclusive. In this sense, the method P comprises either step /Kd/ or step /Kd′/.

Step /D/ may comprise a subsidiary step which comprises:
comparing the reference vacuum level Nr to a threshold vacuum level Ns, the threshold vacuum level Ns being determined so as to correspond to a vacuum level sufficient to allow gripping object 100, and
determining that the plurality of gripping members 13 is capable of gripping the object if the reference vacuum level Nr is greater than or equal to the threshold vacuum level Ns.

In other words, the threshold vacuum level Ns may be determined so as to correspond to a vacuum level which allows obtaining a gripping force, by the plurality of gripping members 13, that is sufficient to grasp and move object 100 without said object “unhooking” from the plurality of gripping members.

Alternatively, the threshold vacuum level Ns is determined so as to correspond to a vacuum level at which none of the plurality of gripping members 13 has a leak. Alternatively, the threshold vacuum level Ns is determined so as to correspond to a vacuum level at which less than 10%, preferably less than 5%, of the plurality of gripping members 13 have a leak.

The threshold vacuum level may be updated according to the number of gripping members having a leak, in order to obtain a gripping force sufficient to grasp the object. For example, if one gripping member among the n gripping members has a leak, the updated vacuum level will be greater than the initial vacuum level because the mass of the object to be grasped will be distributed over n−1 gripping members instead of over n gripping members.

Sequence /K/ may be omitted when the reference vacuum level Nr is greater than or equal to the threshold vacuum level Ns. This makes it possible to verify that there is a need to perform the iterative sequence /K/. Since the plurality of valves 27 are switched to their respective closed position F during step /B/, it is possible to obtain an initial vacuum level that is already greater than the threshold vacuum level Ns. Consequently, it may be chosen to omit the iterative sequence aimed at identifying one or more gripping members 13 exhibiting a leak. Sequence /K/ may therefore be optional. Indeed, if the initial vacuum level measured during step /D/ is greater than the threshold vacuum level Ns, either no gripping member 13 has a leak or only some gripping members 13 have a leak without this impairing the gripping of object 100.

Expressed in another formulation, sequence /K/ is carried out when the reference vacuum level Nr is lower than the threshold vacuum level Ns. Alternatively, the iterative sequence /K/ may be carried out if the reference vacuum level Nr is lower than the threshold vacuum level Ns by at least 10%, preferably by at least 5%.

Step /Ka/ may comprise switching a single valve 27 among the plurality of valves 27 into the respective open position O. Thus, in relation to the iterative formulation of sequence /K/, step /Ka/ of each iteration of rank k may comprise switching a k^{th} single valve 27 among the plurality of valves 27 into the respective open position O, the integer n preferably being equal to the number of valves 27 among the plurality of valves 27. This allows more precisely controlling said one or more corresponding gripping members 13 associated with the k^{th} single valve 27. In other words, said one or more associated corresponding gripping members 13 are controlled individually.

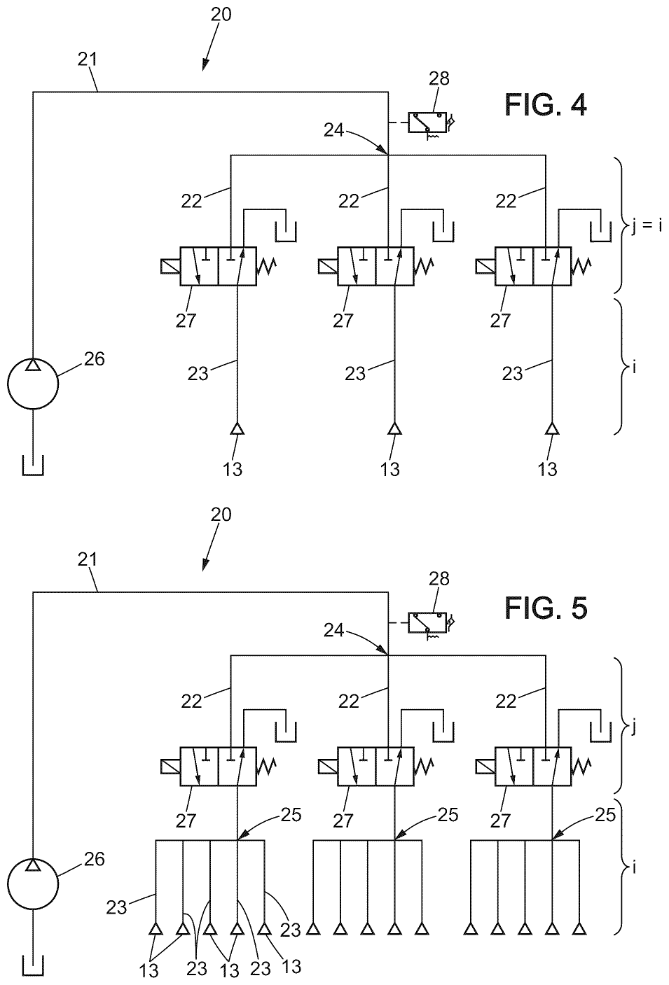

Preferably, as shown in FIG. 4, each valve 27 may be associated with a single corresponding gripping member 13 among the plurality of gripping members 13. This allows individually monitoring each gripping member 13 and thus identifying with certainty a leaking gripping member 13 among the plurality of gripping members 13. In the case where each valve 27 is associated with a single corresponding gripping member 13 among the plurality of gripping members 13, and the step /Ka/ of each iteration of rank k comprises switching a k^{th} single valve 27 among the plurality of valves 27 into the respective open position O, then integer n may be equal to the number of gripping members 13 among the plurality of gripping members 13.

Step /Ka/ of each iteration of rank k may comprise switching a plurality of k^{th} valves 27 among the plurality of valves 27 into the respective open position O. In particular, step /Ka/ of each iteration of rank k may comprise switching a group of k^{th} valves 27 among the plurality of valves 27 into the respective open position O. In other words, the plurality of valves 27 may be divided into groups of valves 27, each iteration of rank k comprising switching the valves 27 of one of the groups of valves 27 into the open position O during step /Ka/, these valves 27 being called “k^{th} valves 27”. Such an approach allows performing a dichotomous identification of gripping members 13 exhibiting a leak, which is advantageously rapid when a small number of gripping members 13 among the plurality of gripping members 13 have a leak. This accelerates the identification of the valve(s) 27 associated with one or more gripping members 13 exhibiting a leak.

Sequence /K/ may be repeated with at least one other valve 27 among the plurality of valves. Sequence /K/ may also be repeated with each valve 27 among the plurality of valves. Also, in connection with the iterative formulation of sequence /K/, each valve 27 among the plurality of valves 27 may be switched into the respective open position O during step /Ka/ in at least one iteration of rank k among the plurality of iterations of the iterative sequence /K/. This ensures that each of the valves 27 associated with one or more gripping members 13 exhibiting a leak is identified.

The iterative sequence may be discontinued after the iteration of rank n. Each iteration of rank k may comprise a step /Kg/ directly or indirectly following step /Kd/ or /Kd′/ and which comprises incrementing rank k by 1 and comparing rank k to integer n. In the case where rank k is equal to integer n, then the iterative sequence is discontinued.

With reference to the variant in FIG. 6, sequence /K/ may comprise a step /Ke/ directly or indirectly following step /Kd/ and which comprises comparing the vacuum level N(k) measured during step /Kc/ to the threshold vacuum level Ns. Step /Ke/ may also comprise determining that gripping members 13 of the sets of gripping members corresponding to the valves in their closed position F are capable of gripping the object if this measured reference vacuum level (N(k)) is greater than or equal to the threshold level Ns.

Sequence /K/ may be repeated with at least one other valve 27 among the plurality of valves, the repeating of sequence /K/ being discontinued when the vacuum level N(k) measured in step /Kc/ is greater than or equal to the threshold vacuum level Ns.

Thus, in relation to the iterative formulation of sequence /K/, step /Ke/ comprises comparing the k^{th} vacuum level N(k) measured during step /Kc/ in the iteration of rank k, to the threshold vacuum level Ns, the iterative sequence /K/ being discontinued after step /Ke/ in the iteration of rank k during which the k^{th} vacuum level N(k) measured during step /Kc/ is greater than or equal to the threshold vacuum level Ns. This makes it possible to interrupt the method P as soon as the threshold vacuum level Ns is reached, i.e. as soon as it is certain that no gripping member 13 has a leak or that the gripping of object 100 is ensured, and thus allows shortening the execution time of the method P. In other words, iterative sequence /K/ may be repeated until the measured vacuum level reaches the threshold vacuum level Ns. Thus, iterative sequence /K/ may therefore be discontinued before the iteration of rank n, in the iteration of rank k during which the k^{th} vacuum level N(k) measured during step /Kc/ is greater than or equal to the threshold vacuum level Ns. Step /Ke/ may directly or indirectly follow step /Kg/.

Sequence /K/ comprises a step /Kf/ directly or indirectly following step /Kd/ and which comprises updating the reference vacuum level Nr to coincide with the vacuum level N(k). Thus, in relation to the iterative formulation of sequence /K/, each iteration of rank k may comprise a step /Kf/ directly or indirectly following step /Kd/ and which comprises updating the reference vacuum level Nr to coincide with the k^{th} vacuum level N(k). In other words, the value of the reference vacuum level Nr, initially corresponding to the measurement of the vacuum level during step /D/ (or possibly during step /Kb/ in the previous iteration (i.e. of rank k−1) in the case of the iterative sequence), is replaced by the value of the vacuum level measured during step /Kb/. This updates the reference vacuum level Nr to the vacuum level measured during step /Kb/. In this sense, the reference vacuum level is a buffer variable, i.e. one whose value is modifiable, and is used to compare and evaluate the vacuum levels subsequently measured.

According to the variant in FIG. 7, sequence /K/ comprises a step /Kh/ directly or indirectly following step /Kd/ and which comprises switching said at least one valve 27 among the plurality of valves 27 into the closed position F. Thus, in relation to the iterative formulation of sequence /K/, each iteration of rank k may comprise a step /Kh/ directly or indirectly following step /Kd/ and which comprises switching said at least one k^{th} valve 27 among the plurality of valves 27 into the respective closed position F. Comparison can be made between the k^{th} vacuum level N(k) in each iteration of rank k and the reference vacuum level Nr measured in step /D/. This avoids updating the reference vacuum level Nr, thereby saving computing power and computer memory.

In the variant of FIG. 7, steps /Ke/ and /Kf/ are not carried out.

Still according to the variant of FIG. 7, the method P may comprise a step /E/after iterative sequence /K/ and which comprises switching, into the open position O, each of the valves 27 among the plurality of valves 27 which have been identified as being associated with a set of corresponding gripping members 13 exhibiting a leak.

According to an equivalent variant of the method as described above, vacuum sensor 28 may be adapted to measure a pressure in pneumatic circuit 20 between vacuum source 26 and the plurality of valves 27. The pressure may be measured in Pa or in bar or in any other pressure unit. According to this variant, it is identified during step /Kd/ that at least one of said one or more corresponding gripping members 13 associated with said at least one k^{th} valve 27 has a leak in the case where the k^{th} pressure is lower than a reference pressure measured during step /D/. According to this variant, the subsidiary step of step /D/ may comprise comparing the reference pressure with a threshold pressure, iterative sequence /K/ being carried out if the reference pressure is higher than the threshold pressure. The threshold pressure may be determined in a manner similar to the threshold vacuum level Ns.

According to another aspect, a method may be proposed for moving object 100 from an initial point to an end point via pneumatic gripping system 10, said method being carried out after the vacuum control method P.

Pneumatic gripping system 10 is now described in more detail with reference to FIGS. 2, 4 and 5.

Pneumatic gripping system 10 may comprise a robotic arm 11. Each of gripping members 13 may be connected to a mobile end 12 of robotic arm 11. Pneumatic circuit 20 may be integrated into robotic arm 11. Robotic arm 11 may be a polyarticulated arm, in particular defining at least six axes of rotation and adapted to move and/or orient mobile end 12 according to six degrees of freedom.

Pneumatic circuit 20 may comprise at least one primary pipe 21. Vacuum source 26 may be arranged at primary pipe 21. The at least one sensor may be adapted to measure a vacuum level at primary pipe 21.

Pneumatic circuit 20 may comprise a plurality of secondary pipes 22. Each valve 27 among the plurality of valves 27 may be arranged at a respective secondary pipe 22 among the plurality of secondary pipes 22. Pneumatic circuit 20 may comprise at least one primary node 24 connecting primary pipe 21 to one or more, or even all, of the plurality of secondary pipes 22.

Pneumatic circuit 20 may comprise a plurality of tertiary pipes 23. Each gripping member 13 among the plurality of gripping members 13 may be arranged at a tertiary pipe 23 among the plurality of tertiary pipes 23. Pneumatic circuit 20 may comprise at least one secondary node 25 connecting secondary pipe 22 of each valve 27 to one or more, or even all, of tertiary pipes 23 supplying said one or more corresponding gripping members 13 associated with valve 27.

Each valve 27 may be of the “3/2” type, in this sense that it distributes fluid between three channels, typically an inlet, an outlet, and a vent hole. Pneumatic circuit 20 may comprise an auxiliary pipe connected to the vent hole of each valve 27. In one non-limiting variant, the valve may be a 4/2 valve or a set of 2/2 valves.

Particularly advantageously, in the method as described above, pneumatic gripping system 10 comprises a single vacuum sensor 28 between vacuum source 26 and the plurality of valves 27. Alternatively, the pneumatic gripping system may comprise at least two vacuum sensors 28 adapted to measure a vacuum level in pneumatic circuit 20 between vacuum source 26 and the plurality of valves 27. This provides a redundant system in the event of failure of one of the sensors, for example. Preferably, the pneumatic gripping system may comprise at least three vacuum sensors 28 adapted to measure a vacuum level in pneumatic circuit 20 between vacuum source 26 and the plurality of valves 27. This makes it possible to identify an erroneous measurement of one of the sensors.

Furthermore, pneumatic gripping system 10 may comprise one or more additional gripping members 13 in addition to said plurality of gripping members 13, said one or more additional gripping members 13 not being required for gripping object 100. Also, the pneumatic gripping system may comprise one or more additional valves 27 in addition to said plurality of valves 27. In other words, the pneumatic gripping system may comprise, in total, I gripping members 13 and J valves 27, I and J being integers greater than i and j respectively.

The vacuum source may be a mechanical motorized vacuum pump or a venturi vacuum generator.

One or more, or even all, of the i gripping members 13 may comprise a suction cup. In the case of a suction cup, it is understood that a leak may occur when the mouth or skirt of the suction cup is not in contact over its entire circumference with the object to be grasped. Such a lack of contact may result from poor positioning of the suction cup, the dimensions of the object, an uneven surface of the object, or a damaged suction cup.

According to another aspect, a computer program may be provided comprising instructions for implementing the method P as described above.

According to another aspect, a computer-readable storage medium may be provided on which is stored a program for implementing the method P as described above when this program is executed by a processor.

Finally, at least one control unit may be provided for executing the method P as described above.

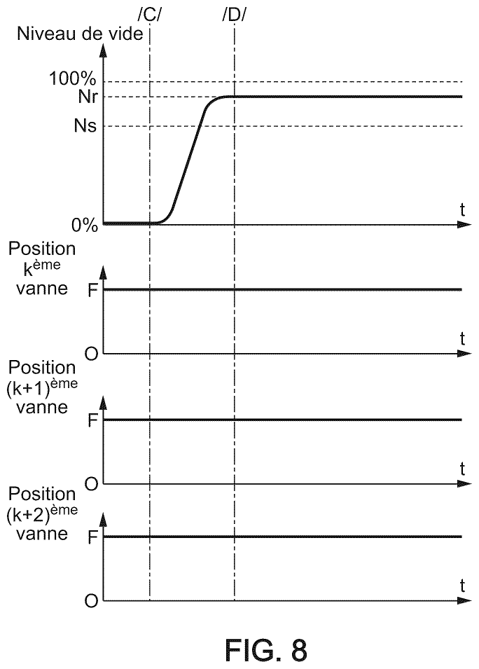

Several scenarios for implementing the control method as described above are now described with reference to FIGS. 8 to 11. FIGS. 8 to 11 respectively include a graph that illustrates the evolution of the vacuum level as measured by vacuum sensor 28 during the method and the position of three valves 27 during the method, in this case the position of a k^{th} valve 27, (k+1)^{th} valve 27, and a (k+2)^{th} valve 27. In each of the scenarios, each of the k^{th}, (k+1)^{th}, (k+2)^{th} valves 27 may be switched individually during a respective iteration of rank k, k+1 and k+2. According to one particular case, the integer n may be equal to 3 so that pneumatic gripping system 10 comprises a first valve 27, a second valve 27, and a third valve 27 respectively coinciding with k^{th} valve 27, (k+1)^{th} valve 27, and (k+2)^{th} valve 27, and respectively switched individually during an iteration of rank 1, an iteration of rank 2, and an iteration of rank 3 of iterative sequence /K/.

In each of the scenarios of FIGS. 8 to 11, the method is initially considered to be in a state where steps /A/ and /B/ have been carried out.

In each of the scenarios of FIGS. 8 to 11, the carrying out of step /C/ is represented, which results in an increase in the vacuum level, from 0% to the reference vacuum level Nr. In each of the scenarios of FIGS. 8 to 11, the carrying out of step /D/ is represented, during which the reference vacuum level Nr is measured by said at least one vacuum sensor 28.

We will first refer to the scenario of FIG. 8. The initial reference vacuum level Nr measured during step /D/ is greater than the threshold vacuum level Ns. In such case, iterative sequence /K/ is advantageously omitted in order to reduce the time taken to complete the vacuum control method P. Thus, as can be seen in FIG. 8, each of the valves 27 remain in the respective closed position.

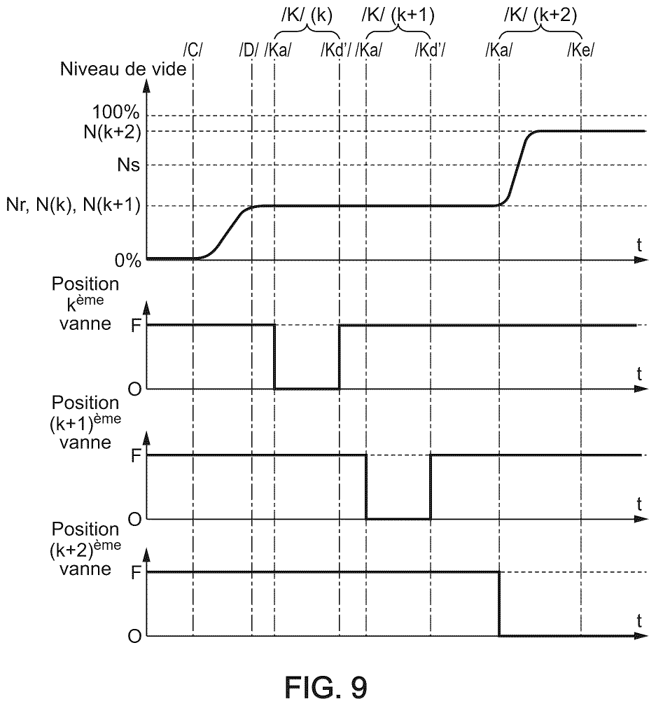

We will now refer to the scenario of FIG. 9. The initial reference vacuum level Nr measured during step /D/ is lower than the threshold vacuum level Ns. Iterative sequence /K/ is then initiated:
An iteration of rank k is carried out during which the k^{th} valve 27 is switched into the respective open position. The k^{th} vacuum level N(k) here is equal to the reference vacuum level Nr. It is therefore deduced that none of said one or more corresponding gripping members 13 associated with said at least one k^{th} valve 27 has a leak. Thus the k^{th} valve 27 is switched to the respective closed position;
An iteration of rank k+1 is carried out during which the (k+1)^{th} valve 27 is switched into the respective open position. The (k+1)^{th} vacuum level N(k+1) here is equal to the reference vacuum level Nr. It is therefore deduced that none of said one or more corresponding gripping members 13 associated with said at least one (k+1)^{th} valve 27 has a leak. Thus the (k+1)^{th} valve 27 is switched to the respective closed position;
An iteration of rank k+2 is carried out during which the (k+2)^{th} valve 27 is switched into the respective open position. The (k+2)^{th} vacuum level (N(k+2)) here is greater than the reference vacuum level Nr. The increase in the (k+2)^{th} vacuum level (N(k+2)) relative to the reference vacuum level Nr is due to the removal of a leak source from pneumatic circuit 20. It is therefore deduced that at least one of said one or more corresponding gripping members 13 associated with said at least one k^{th} valve 27 has a leak. In the illustrated example, the (k+2)^{th} valve 27 is kept in its respective open position. In other words, the iteration of rank k+2 is completed without the (k+2)^{th} valve 27 being switched to its respective closed position. Finally, according to the illustrated scenario, the (k+2)^{th} vacuum level (N(k+2)) is greater than the threshold vacuum level. The iterative sequence is then discontinued either because it is deduced that none of the corresponding gripping members 13 associated with a valve 27 other than the k^{th}, (k+1)^{th}, (k+2)^{th} valves 27 has a leak, or because it is deduced that the vacuum level reached is sufficient to allow the gripping of object 100 by means of pneumatic gripping system 10.

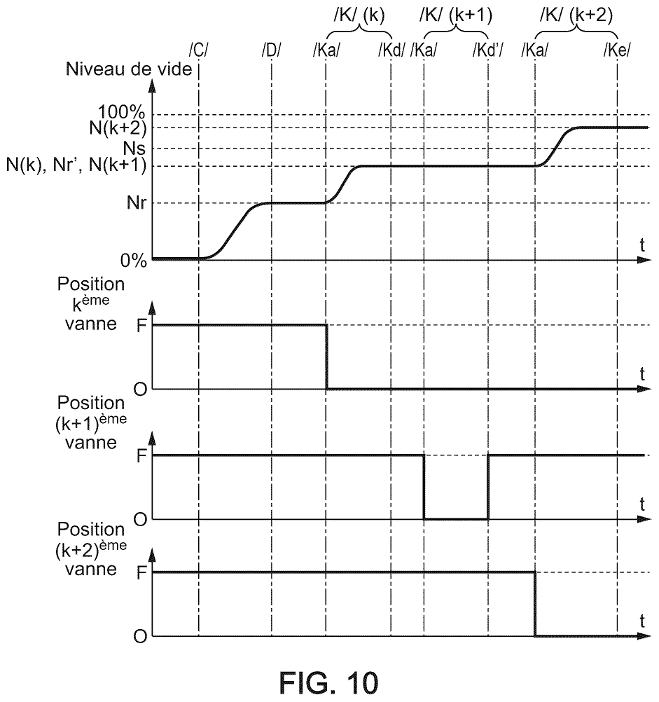

We will now refer to the scenario of FIG. 10. The scenario of FIG. 10 differs from the scenario of FIG. 9 in that the k^{th} vacuum level N(k) here is higher than the reference vacuum level Nr. It is deduced that at least one of said one or more corresponding gripping members 13 associated with said at least one k^{th} valve 27 has a leak. Subsequently, the reference vacuum level Nr is updated to coincide with the k^{th} vacuum level N(k). In other words, an updated reference vacuum level Nr′ corresponding to the k^{th} vacuum level N(k) is defined. It is noteworthy that, in the illustrated example, the iteration of rank k is completed without the k^{th} valve 27 being switched to its respective closed position and the k^{th} valve 27 is kept in its respective open position during the following iterations k+1 and k+2. The iterations of rank k+1 and k+2 are identical to the scenario of FIG. 9.

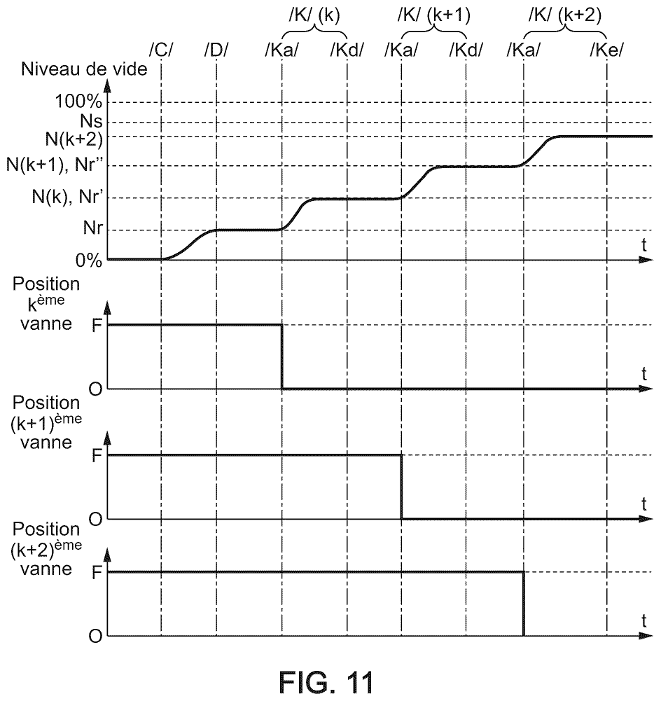

We will now refer to the scenario of FIG. 11. The scenario of FIG. 11 differs from the scenario of FIG. 10 in that the (k+1)^{th} vacuum level N(k+1) here is greater than the reference vacuum level Nr, in this case the updated reference vacuum level Nr′. It is deduced that at least one of said one or more corresponding gripping members 13 associated with said at least one (k+1)^{th} valve 27 has a leak. Subsequently, the reference vacuum level Nr is again updated to coincide with the (k+1)^{th} vacuum level N(k+1). In other words, an updated reference vacuum level Nr″ is defined, corresponding to the (k+1)^{th} vacuum level N(k+1). In the illustrated example, the iteration of rank k+1 is completed without the (k+1)^{th} valve 27 being switched to the respective closed position and the (k+1)^{th} valve 27 is kept in its respective open position during the next iteration k+2.

In the scenario of FIG. 11, each of the k^{th}, (k+1)^{th}, (k+2)^{th} valves 27 are associated with at least one corresponding gripping member 13 which has a leak, for example a corresponding gripping member 13 that is incorrectly positioned on the object.

Finally, it is noteworthy that the (k+2)^{th} vacuum level N(k+2) is lower than the threshold vacuum level. Iterative sequence /K/ may be repeated in a new iteration if rank k+2 less than integer n is not reached, for example if certain valves 27 have not been verified by being the object of an iteration of iterative sequence /K/. On the other hand, if rank k+2 is equal to integer n, then the iterative sequence is discontinued. In this case, it may for example be deduced that the final vacuum level corresponding to the (k+2)^{th} vacuum level N(k+2) does not allow the gripping of object 100. Thus, the plurality of gripping members 13 may be repositioned on object 100 at a different location and the control method may be repeated.

1. A vacuum control method for a pneumatic gripping system which comprises a vacuum source, a plurality of gripping members, and a pneumatic circuit configured to place the plurality of gripping members in fluid communication with the vacuum source, the pneumatic circuit comprising a plurality of valves, each valve being associated with a corresponding set of gripping members comprising one or more gripping members among the plurality of gripping members, each valve being configured to switch between a closed position in which said valve places said corresponding set of gripping members in fluid communication with the vacuum source and an open position in which said valve places said corresponding set of gripping members in fluid communication with the atmosphere, the pneumatic gripping system further comprising at least one vacuum sensor adapted to measure a vacuum level in the pneumatic circuit between the vacuum source and the plurality of valves, the method comprising:
/A/ activating the vacuum source in order to establish a negative pressure between the plurality of gripping members and an object to be gripped,
/B/ switching the plurality of valves into their respective closed position,
/C/ positioning the plurality of gripping members on the object,
/D/ measuring a reference vacuum level by means of said vacuum sensor,
the method comprising the following sequence /K/:
/Ka/ switching at least one valve among the plurality of valves into the open position,
/Kb/ measuring a vacuum level) by means of said vacuum sensor,
/Kc/ comparing the measured vacuum level) with the reference vacuum level,
/Kd/ determining that at least one of the gripping members in the set of gripping members corresponding to said at least one valve has a leak, in the case where the measured vacuum level) is greater than the reference vacuum level.

2. The method according to claim 1, wherein the sequence /K/ comprises a step /Kd′/ of switching said at least one valve into the closed position in the case where the measured vacuum level) is equal to the reference vacuum level.

3. The method according to claim 1, wherein step /D/ comprises a subsidiary step which comprises:
comparing the reference vacuum level with a threshold vacuum level, the threshold vacuum level being determined so as to correspond to a vacuum level sufficient to allow gripping the object, and
determining that the plurality of gripping members is capable of gripping the object if the reference vacuum level is greater than or equal to the threshold vacuum level.

4. The method according to claim 3, wherein the sequence /K/ is not carried out when the reference vacuum level is greater than or equal to the threshold vacuum level.

5. The method according to claim 1, wherein step /Ka/ comprises switching a single valve among the plurality of valves into its respective open position.

6. The method according to claim 1, wherein the sequence /K/ is repeated with at least one other valve among the plurality of valves.

7. The method according to claim 1, wherein the sequence /K/ is repeated with each valve among the plurality of valves.

8. The method according to claim 3, wherein the sequence /K/ comprises a step /Ke/ directly or indirectly following step /Kd/ and which comprises:
comparing the vacuum level) measured during step /Kb/ with the threshold vacuum level, and
determining that the gripping members of the sets of gripping members corresponding to the valves in their closed position are capable of gripping the object if the measured reference vacuum level) is greater than or equal to the threshold level.

9. The method according to claim 3, wherein the sequence /K/ is repeated with at least one other valve among the plurality of valves, the repeating of the sequence /K/ being discontinued when the vacuum level measured in step /Kb/ is greater than or equal to the threshold vacuum level.

10. The method according to claim 1, wherein the sequence /K/ comprises a step /Kf/ directly or indirectly following step /Kd/ and which comprises updating the reference vacuum level to coincide with the vacuum level).

11. The method according to claim 1, wherein the sequence /K/ comprises a step /Kh/ directly or indirectly following step /Kd/ and which comprises switching said at least one valve among the plurality of valves into the closed position.

12. The method according to claim 11, comprising a step /E/ which follows the iterative sequence /K/ and which comprises switching, into the open position, each of the valves among the plurality of valves that have been identified as being associated with a corresponding set of gripping members exhibiting a leak.

13. The method according to claim 1, wherein the pneumatic gripping system comprises a single vacuum sensor between the vacuum source and the plurality of valves.

14. A computer program comprising instructions for implementing the method according to claim 1.

15. A computer-readable storage medium on which is stored a program for implementing the method according to claim 1 when the program is executed by a processor.

16. A pneumatic gripping system comprising a vacuum source, a plurality of gripping members, and a pneumatic circuit configured to place the plurality of gripping members in fluid communication with the vacuum source, the pneumatic circuit comprising a plurality of valves, each valve being associated with a set of one or more corresponding gripping members among the plurality of gripping members, said valve being configured to switch between a closed position in which said valve places said set of one or more corresponding gripping members in fluid communication with the vacuum source and an open position in which said valve places said set of one or more corresponding gripping members in fluid communication with the atmosphere, the pneumatic gripping system further comprising at least one vacuum sensor adapted to measure a vacuum level in the pneumatic circuit between the vacuum source and the plurality of valves, and at least one control unit for carrying out the method according to claim 1.
